(19) United States
(12) Patent Application Publication
(10) Pub. No.: US 2006/0201894 A1
(43) Pub. Date: Sep. 14, 2006

(54) Insert molded rare earth magnet in locker accessories

(76) Inventors: George W. Wood, Minneapolis, MN (US); Tang Chi Wai, Sanpokong (HK)

Correspondence Address: BECK AND TYSVER P.L.L.C., 2900 THOMAS AVENUE SOUTH, SUITE 100, MINNEAPOLIS, MN, 55416, US

(21) Appl. No.: 11/077,811

(22) Filed: Mar. 11, 2005

(51) Int. Cl. B42F 17/00

(52) U.S. Cl. 211/10; 211/126.1

(57) ABSTRACT

A locker accessory is presented with one or more rare earth magnets insert molded into a wall that engages a locker wall or door. The magnet is molded so as to have an outer surface of the magnet flush with the engagement wall of the locker accessory. A dimple within the magnet is used with a corresponding bump the mold to position the magnet in place before the injection of melted resin into the mold. A utility box, an attachment magnet, a magnetic clip, a frame, and a memo pad are presented as locker accessories using the preferred construction.

### FIELD OF THE INVENTION

The present invention relates generally to magnetic accessories for school lockers. More specifically, the present invention relates to locker accessories made through a process of insert molding a rare earth magnet into the rear side of the accessories.

### BACKGROUND OF THE INVENTION

In many school systems, students are assigned a locker for an entire school year. Because the locker often is the first space that a student will consider their “own” outside of their bedroom, students will often go to great lengths to customize the locker. Some students will hang photographs of friends or famous people on their locker door. Others will hang mirrors and create places to store combs and grooming accessories. Still others will organize their school supplies by adding shelves to the locker or by hanging a utility box for pens, pencils, and other supplies. The manufacturing and supplying of these types of locker accessories has become a big business, especially during the annual back-to-school shopping season.

One problem facing manufacturers of locker accessories is how to attach the accessories to the locker. Most school lockers have walls and doors made from steel, which is a ferromagnetic material (i.e., a material that interacts with the magnetic field of a magnet). Consequently, most locker accessory manufacturers now use magnetic attachment methods as oppose to using adhesive tape or foam.

Larger objects, such as the utility box 10 shown in FIG. 1, can be affixed to a locker 20 by gluing a flexible magnetic strip 30 to the back of the box 10. Since the strength of a flexible magnetic strip 30 is directly proportionate to the area of the sheet used, the utility box 10 of FIG. 1 is shown with a magnetic strip 30 covering much of its rear surface. This flexible strip 30 has a binding strength sufficient to support the box and its contents against the door 22 or other interior surface 24 of locker 20.

Other manufacturers of locker accessories have decided to use stronger, rare earth magnets. FIGS. 2 and 3 show a prior art attachment magnet 40. An attachment magnet is a magnet 50 embedded in some type of decorative, non-magnetic body 42, designed for the purpose of holding a sheet of paper or photograph up against a ferromagnetic surface (like a locker or a refrigerator). To hold the magnet 50 in place, a cavity 44 is created in the decorative body 42, either during the molding process or by machining. Alternatively, a close fitting sleeve having a similar cavity can be welded or glued to the decorative body 42. The cavity 44 is sized to barely contain the magnet 50, with the magnet being pressed in place and held either through a friction fit or through the use of epoxy or glue 60.

Unfortunately, there are inherent problems with these prior art locker accessories that have not been identified or remedied in the prior art. What is needed is a cost effective technique to increase the magnetic strength of locker accessories in a secure fashion, without increasing product failures or decreasing the attractiveness of the accessories.

### SUMMARY OF THE INVENTION

The present invention involves the use of one or more rare earth magnets (such as a neodymium or samarium cobalt magnet) within the construction of a locker accessory. These rare earth magnets have a large magnetic field strength for their size, and therefore can withstand the demands found in a typical, school locker environment. To overcome the problem with previous construction techniques, the rare earth magnet is insert molded directly into the locker accessory.

The construction of a locker accessory by insert molding the accessory around one or more rare earth magnets requires a high degree of care and consideration. In order to properly position the magnet in the mold, the preferred embodiment uses a dimple within each magnet, and a corresponding raised area in the mold. The raised area fits within the dimple, so as to position the magnet in place before the injection of the melted plastic into the mold cavity. The strength of the magnet and its susceptibility to heat-induced damage requires careful monitoring of the molding process. The mold temperature must be managed to prevent excessive heat from damaging the magnets. Furthermore, the mold must be cooled sufficiently to allow the plastic to harden and secure the magnet in place when the molded part is removed from the mold. This is especially important since the preferred embodiment mold is ferromagnetic, meaning that the magnet will attached to the mold and will resist being withdrawn from the mold.

The present invention can be used in a variety of locker accessories. A utility box, an attachment magnet, a magnetic clip, a mirror, and a memo pad are presented as examples.

### BRIEF DESCRIPTION OF THE DRAWINGS

FIG. 1 is a perspective drawing of a prior art locker accessory utility box being used in a locker setting.

FIG. 2 is a perspective drawing of a prior art attachment magnet.

FIG. 3 is a cross-sectional view of the prior art attachment magnet shown in FIG. 2 along line 3-3.

FIG. 4 is a perspective view of an array of metal lockers with a utility box of the present invention on the door of one locker.

FIG. 5 is a perspective view of the utility box shown in FIG. 4.

FIG. 6 is a front elevation view of the utility box of FIG. 5.

FIG. 7 is a sectional view of the utility box of FIG. 6 taken along line 7-7.

FIG. 8 is a rear elevation view of the utility box of FIGS. 5 and 6.

FIG. 9 is a partial sectional view of the utility box of FIG. 8 taken along line 9-9.

FIG. 10 is a perspective view of an attachment magnet of the present invention.

FIG. 11 is a side elevational view of a clip magnet of the present invention.

FIG. 12 is a rear perspective view of a frame of the present invention.

FIG. 13 is a sectional view of a mold used to manufacture the utility box of FIG. 8, the mold being used to construct the portion of the utility box taken along line 13-13.

### DETAILED DESCRIPTION OF THE INVENTION

Identification of Problems

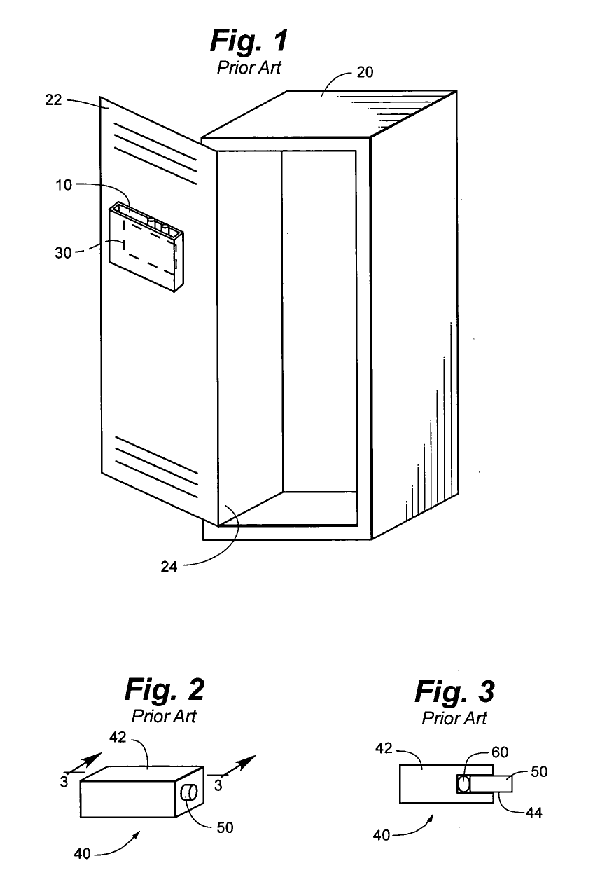

As part of the present invention, the patent applicant has identified various problems with prior art locker accessories which have not been previously recognized in the industry. The school locker is an unusually harsh environment for magnetically attached objects. For example, the slamming of the locker door 22 shown in FIG. 1 will often dislodge the box 10, causing the box 10 and its contents to spill on the inside of the locker 20. Another common occurrence in a school setting is the pounding of locker doors 22 by other students for the explicit purpose of dislodging all magnetic locker accessories attached inside the door 22. These efforts are often successful with the prior art utility box 10.

Unfortunately, it is not easy for locker accessory manufacturers to economically solve this problem. It is not possible to increase the surface area of the magnetic strip 30 enough to provide the required grip, since the utility box 10 has a limited useful size. Although increasing the thickness of the magnetic strip 30 is known to increase the magnetic strength of the strip 30, there are significant disadvantages to using a thicker strip 30. First, a thick strip 30 will be unsightly to users. Since the “coolness” factor is a major selling point of all locker accessories, an unsightly strip 30 will lead to reduced sales. Second, the price of a flexible magnetic strip 30 increases significantly with increased thickness. Third, shipping and handling costs will increase as a heavier, thicker magnetic strip 30 is used. Finally, the total thickness of a utility box 10 is effectively limited by the standard six-inch display peg size used by most major retailers. In order to place four boxes on each display peg, each box 10 must have a thickness of one and one-half inches or less. A box 10 that is slightly thicker will require that each peg contain only three boxes 10, which will greatly affect the number of products that can be displayed simultaneously in the limited space provided by retailers. Given the traditional back-to-school rush, the need to restock the shelves more frequently can realistically lead to an increased incident of empty shelves and a resultant decrease in sales. This means that any increase in the thickness of strip 30 must lead to a decrease in the useable size of box 10 or result in lost sales.

In addition, the adhesive used to attach strip 30 to the back of utility box 10 can loosen over time due to different rates of expansion between the strip 30 and box 10, and due to the effect of humidity on the adhesive itself. This results in circumstances where the magnetic strip begins to peel away from the back of the utility box 10, which is both unsightly and further reduces the ability of the magnetic strip 30 to hold the box 10 to locker door 22.

The movement to rare earth magnets 50 to increase the magnetic strength used by locker accessories has created different problems. At first, rare earth magnets were used only with metallic locker accessories, where the magnetic attraction between the magnet and the locker accessory would help hold the pieces together. In these circumstances, only a modest amount of attachment force was necessary to keep the magnet attached to the locker accessory when the accessory is being removed from the locker. When plastic locker accessories are used with rare earth magnets, a better mechanism to connect the magnet with the locker accessory must be implemented in order to overcome the strong magnetic attraction between the rare earth magnet and the locker door.

In the prior art locker accessories of FIGS. 2 and 3, the rare earth magnet 50 is inserted into a previously created cavity 44 in the accessory. While glue 60 often helps to hold the magnet 50 in place, manufacturers will frequently skip the use of glue 60 during the construction of the attachment magnet 40. This is because the process of gluing the magnet is quite expensive. The price of the glue itself is not insignificant, but the greatest cost is due to the increase in manufacturing costs. Applying glue 60 to the cavity 44 is an extra step in the manufacturing process that adds to the cost. In addition, the glue must be given time to cure apart from any other attachment magnets 40, especially given the attractive force the will exist between two adjacent attachment magnets 40. Finally, it is difficult to apply the glue 60 consistently from product to product, which results in more product rejects during manufacturing, and more product failures during use by customers.

Even without the glue 60, the construction of the attachment magnet 40 shown in FIGS. 2 and 3 works quite well for use on a refrigerator, with the friction fit holding the magnet 50 and body 42 together. However, this construction has caused problems in the locker accessory industry. The problem with the friction fit is that the grip between the accessory body 42 and the magnet 50 is loosened over time. After repeated jolts from door slams and similar impacts, the magnet 50 eventually breaks free from the decorative body 42, resulting in the attachment magnet 40 and the items it was holding falling to the bottom of the locker.

This occurs even when glue 60 is used during construction, since the glue 60 becomes brittle over time. The jarring of the locker door frequently cracks the glue 60 and allows the magnet 50 to separate from the decorative body 42. In addition, the difficulty in applying the glue consistently means that customers will frequently encounter locker accessories where the magnet 50 was not adequately glued to the body 42. When this occurs, the attachment magnet 40 and whatever it is holding will fall.

Finally, the need to create an attractive locker accessory has led manufacturers to use translucent and transparent plastics in their construction. If glue 60 is used to secure the magnet 50 in place in a locker accessory 40, the glue 60 will be visible and be considered unsightly. Similar cosmetic issues are encountered when adhering a magnetic strip 30 to a translucent locker accessory such as box 10.

### First Embodiment of the Present Invention

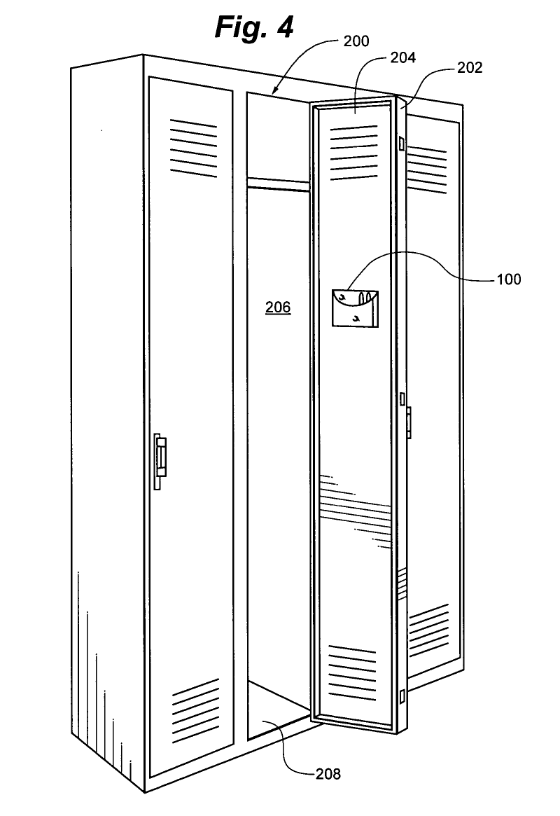

These problems are solved in the present invention. As shown in FIG. 4, a utility box or article holder 100 of the present invention is positioned in locker 200. The utility box 100 is magnetically attached to locker door 202 so as to provide a convenient place for the storage of pens, pencils, combs, and other personal articles. Since utility box 100 is located on the inner surface 204 of door 202, the box 100 will be within the interior 206 of locker 200 when door 202 is closed. As explained above, the connection between the utility box 100 and inner surface 204 is subject to significant stress whenever door 202 is slammed shut or subjected to pounding when closed. This is especially true when the user loads the box 100 with numerous personal items. If the magnetic attraction between the box 100 and door 202 is insufficient, a door slam may cause the box 100 to fall onto the floor 208 of locker 200. With many of the plastics used in the construction of locker utility boxes 100, this impact could cause box 100 to shatter.

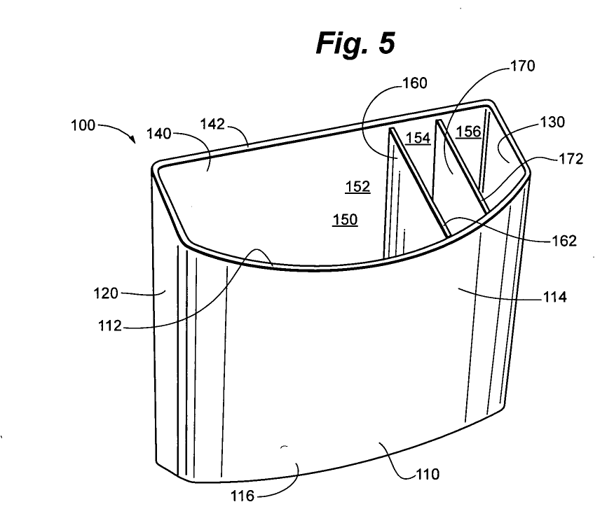

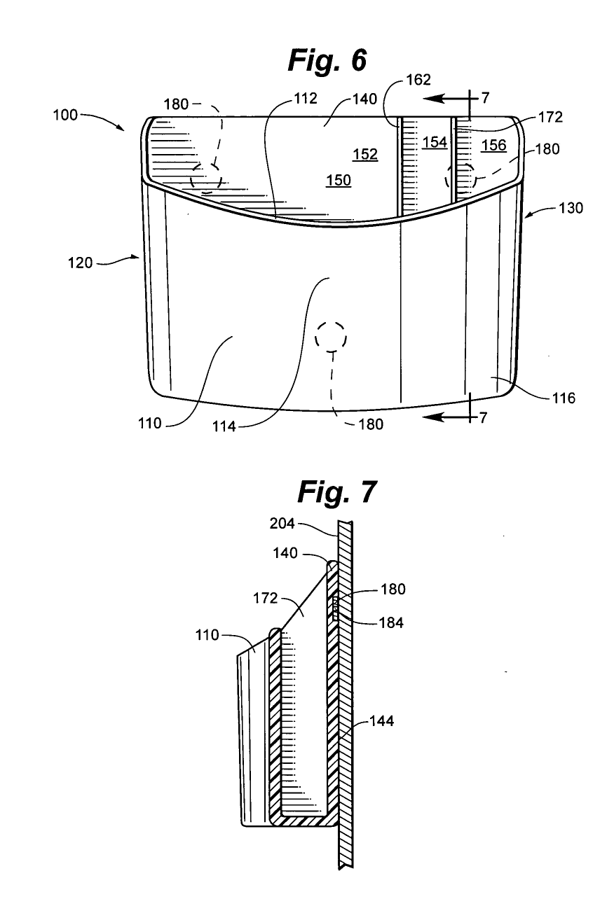

The utility box 100 shown in FIG. 4 has a unique configuration, as shown in more detail in FIGS. 5 and 6. The box 100 has a front wall 110, two side walls 120, 130, a rear wall 140, and a bottom (not shown). The front wall 110 has a top surface 112 arcing downward from the two side walls 120, 130 toward a low point in the middle 114 of front wall 110. The front wall 110 also bows outward at middle 114 away from the rear wall 140. Furthermore, the bottom 116 of front wall 110 curves downward as the front wall 110 extends from the side walls 120, 130 toward its middle 114. This curved bottom 116 of front wall 110 corresponds to the curved shape of the bottom (not shown) of box 100.

Where the front wall 110 abuts the side walls 120, 130, the top 112 of the front wall 110 is significantly lower than the top 142 of the rear wall 140. The tops 122, 132 of the side walls therefore slope upward from the front wall 110 to the rear wall 140. This construction creates a lowered front wall 110, allowing easy access to insert objects into and remove object from the interior 150 of the utility box 100.

The interior 150 is divided into three sections 152, 154, and 156 by interior vertical walls 160, 170. The first section 152 of interior 150 occupies more than fifty percent of the interior 150, allowing for the placement of larger objects into box 100. The second and third sections 154, and 156, are significantly narrower, and are designed for the placement of elongated articles such as pencils and pens. Since the top surface 112 of front wall 110 is below the top surface 142 of the rear wall 140, the top surfaces 162, 172 of interior walls 160, 170 also slope upward as they extend to the rear wall 140, similar to the slope in side walls 120, 130.

As shown best in FIGS. 7, 8, and 9, box 100 is held in place against the interior 204 of locker wall 202 through the use of three magnets 180. These magnets 180 have been molded into the rear wall 140 using a process of insert molding as described in further detail below. To create a strong magnetic force without the use of a thick magnetic sheet, box 100 uses neodymium magnets 180, which are actually made using a neodymium iron boron (NdFeB) alloy. Samarium cobalt (SmCo) magnets may also be used. These magnets 180 are called rare earth magnets because both neodymium and samarium are found in the rare earth elements on the periodic table. The magnets 180 are made from powdered metal alloys that are compacted in the presence of a magnetic field and then sintered into a hardened magnet 180. Rare earth magnets 180 have a large magnetic field strength for their size, and therefore can withstand the demands found in a typical, school locker environment.

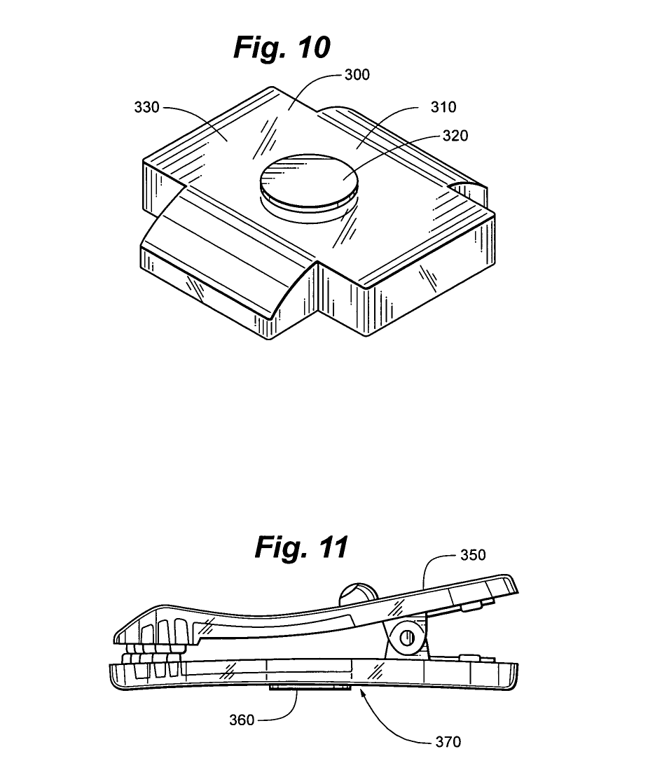

The rare earth magnets 180 are positioned in rear wall 140 such that the outer surface 182 of the magnets 180 are approximately flush with the outer surface 144 of rear wall 140. The smoothness of the combined surface 144, 182 has significant advantages over prior art configurations where the magnet outer surface 182 protrudes beyond the rear wall 140 or is inset within rear wall 140. When the magnet 180 protrudes beyond the rear wall 140, it unnecessarily increases the thickness of the entire utility box 100, and produces an unsightly appearance. When inset within-rear wall 140, the increased distance between the magnet 180 and the inner wall 204 of locker door 202 results in a decrease in the strength of the magnetic attraction holding the box 100 in place. In some circumstances, the protrusion of the magnet 180 beyond the wall of the locker accessory will not extend the size of the accessory in a critical dimension (no significant increase in the cost of construction, shipment, or display). In these cases, allowing the magnet to slightly extend beyond the wall of the locker accessory does not have a significant disadvantage. For instance, when a slightly protruding magnet increases the thickness of an attachment magnet, such thickness increase may not have any cost increase associated with it (see FIGS. 10 and 11).

Rare earth magnets 180 that are flush against a wall 140 of a locker accessory can be constructed with a central opening or dimple 184, which are shown in the figures extending all the way through magnets 180. These openings 184 can also be formed as indentations in which the opening 184 does not extend all the way through the magnet 180. In the present application, the term dimple is intended to cover both through-holes as shown in the figures and any other indented, hollowed, or depressed area in the outer surface 182 of magnet 180. The dimple 184 is used in the insert molding process to help position the magnets 180 in place before the injection of melted plastic resin into the mold, as described below.

### Additional Embodiments of the Present Invention

The present invention is relevant to other locker accessories in addition to a utility box 100. FIG. 10 shows an attachment magnet 300 having a decorative, non-magnetic body 310 with a rare earth magnet 320 insert molded into an engagement surface 330. The engagement surface 330 is so called because this surface 330 is placed against a locker door during use. A slight protrusion of the magnet 320 beyond the engagement surface 330 is shown in FIG. 10.

Similarly, FIG. 11 shows a decorative magnetic clip 350 with a rare earth magnet 360 insert molded into its engagement face 370. Clip 350 is shown in a novelty configuration involving an alligator head and teeth, but the present invention would incorporate any configuration of magnetic clip locker accessory.

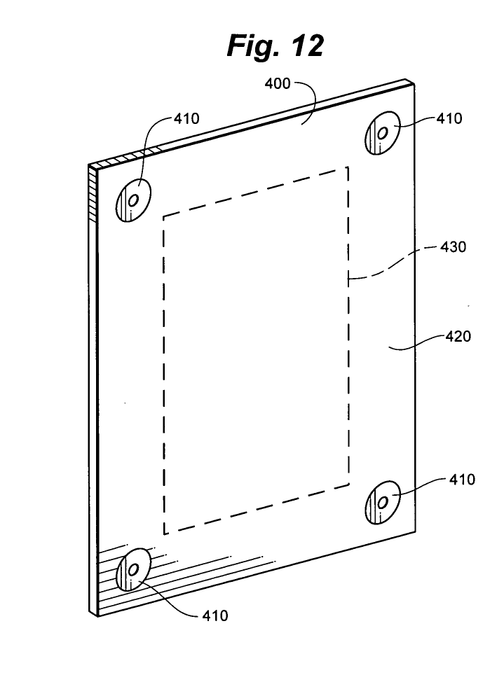

FIG. 12 shows a plastic frame 400 in which four rare earth magnets 410 are insert molded flush with an engagement surface 420. As with the other present invention locker accessories, the engagement surface 420 is generally flat so as to lie directly against the surface of a locker wall or door. The frame 400 could be used to hold a white board memo pad, a pad of paper, a mirror, or a photograph opposite the engagement surface 420, all of which are generically represented in FIG. 12 as dotted line 430.

### Manufacture of the Present Invention

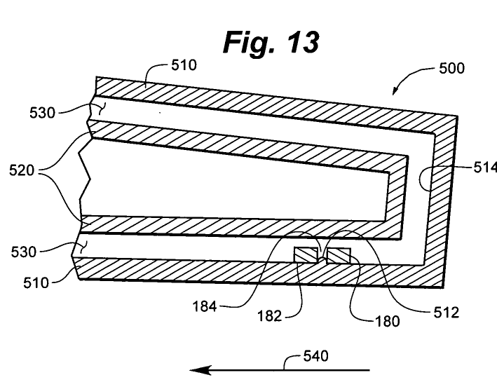

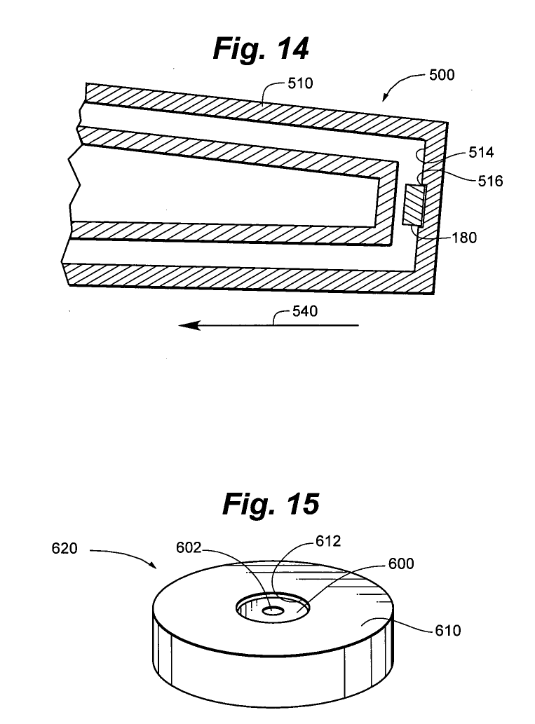

The present invention locker accessories are formed using an insert molding process, which is a special form of injection molding. Injection molding is a manufacturing process in which melted plastic resin is injected into a mold under pressure, such as mold 500 shown in FIG. 13. After the plastic has cooled, the plastic part is ejected and the process repeats using the same mold 500.

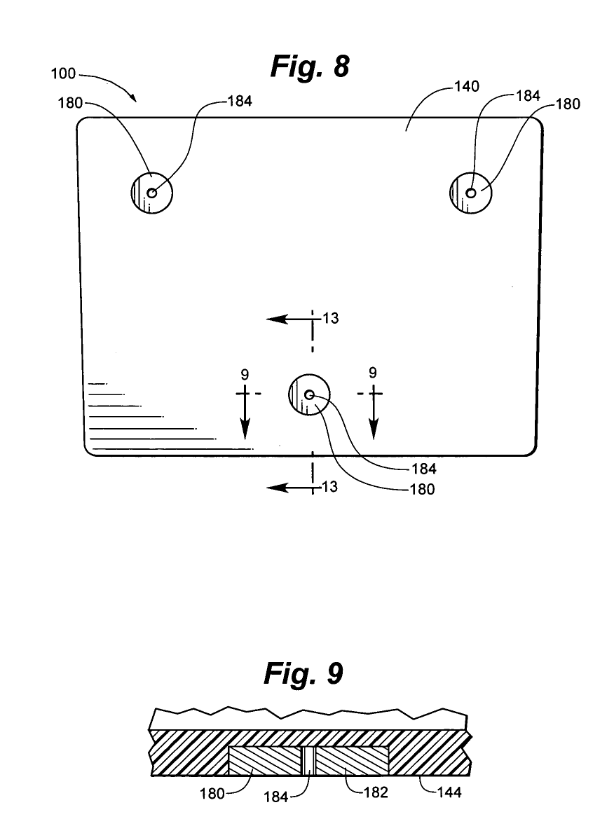

Mold 500 is shown in cross-section in FIG. 13, forming roughly that portion of utility box 100 shown in FIG. 8 along cross-sectional line 13. The mold 500 is the inverse of the desired shape, and is usually made from hardened steel. Molds are formed using at least two pieces, known as the cavity 510 and the core 520. The void 530 between these two pieces 510, 520 is injected with melted plastic to form the locker accessory 100. When manufacturing these pieces, care must be taken to ensure that the plastic parts will not be trapped in the mold, and that the melted plastic can flow freely through the mold 500 so as to completely fill the void 530 before the plastic solidifies.

The plastic or resin used in injection molding can be of a variety of compositions, including polyethylene, polystyrene, polypropylene, polyvinyl chloride, and thermoplastic elastomers. Typically, the plastic starts in pellet form, and is melted before injection into the mold. It is important that the plastic enter the mold at the correct temperature and pressure, so that the resin will flow to all parts of the mold. It is possible to injection mold a magnetic polymer using magnetic powder in the plastic resin, so as to create a completely magnetic piece. The present invention does not do this, as the cost would be prohibitive and the look of the resulting locker accessory would not be satisfactory.

Instead, the present invention molds a rare earth magnet 180 directly into the rear wall 140 of the utility box 100. This process is called insert injection molding, a phrase which covers any circumstance where an insert piece such as magnet 180 is placed within void 530 between the mold cavity 510 and core 520 prior to the injection of the melted resin. As the resin cools, it shrinks around the magnet 180 to hold it in place. Irregularities on the surface of the rare earth magnet 180 help the hardened resin and the magnet 180 to form a strong, mechanical bond. This bonding is significantly stronger and more consistent than that provided by machining an opening and retaining the magnet through a standard friction fit or glue, as was described above in connection with FIGS. 2 and 3. The result of insert molding is a plastic locker accessory 100 with the rare earth magnet 180 encapsulated by the plastic.

The decision to insert mold the magnet 180 directly into the rear wall 140 required that numerous problems be overcome. First, it can often be difficult to load the magnet 180 into the correct position in the mold cavity 510 prior to each injection. To assist in the manual process of inserting the magnet 180 into the mold, the present invention creates a bump or protrusion 512 in the cavity 510 of mold 500. As explained above, the rare earth magnet 180 has a dimple 184 located on its outer surface 182. This dimple 184 is placed over bump 512, therefore ensuring that magnet 180 is properly positioned in the mold. A separate bump 512 is positioned in cavity 510 for each rare earth magnet 180 to be used in the locker accessory.

Another technique for properly positioning an insert piece in the mold is to create an indentation in the mold cavity 510 itself. This indentation would match the size and shape of the magnet 180, which would allow the magnet 180 to be positioned in the indentation before the resin is injected. The use of an indentation to position magnet 180 would mean that the magnet 180 would protrude slightly beyond the rear wall 140 of the utility box 100. While this would not seriously affect the performance on the utility box 100 as it attaches to a locker 200, it would unnecessarily increase the width of the box 100. In addition, a slightly protruding magnet 180 would make extraction of the box from the mold cavity 510 much more difficult. This is because the box 100 is removed by sliding the box 100 in the direction of arrow 540 (parallel to the wall surface of the mold cavity 510). A protruding magnet 180 could not easily slide out of the indentation by simply by sliding in this direction 540.

If the locker accessory mold 500 required a magnet at the inner most side 514 of the mold cavity 510, it would be a simple matter to position the magnet with an indentation 516, as shown in FIG. 14. This is because a magnet at position 514 would be withdrawn perpendicular (arrow 540) to the wall of the mold cavity 510 at that position 514. This technique is used with the attachment magnet 300 and the clip magnet 350 locker accessories shown in FIGS. 10 and 11.

Of course, while bumps 512 help position the magnets 180 before the injection process, the same bumps 512 can hinder the extraction of the locker accessory 100 from the mold 500 after the plastic has cooled. Similarly, while the use of a metallic mold 500 would help hold the magnets in place 180 during the injection process, the steel mold will also hinder extraction since the magnets 180 will grip the mold cavity 510 itself. With the magnets 180 resisting extraction from the mold 500, an improper molding technique will cause the magnets 180 to move relative to the rest of the locker accessory 100 during extraction. This would reduce the bond between the rear wall 140 and the magnet 180, making the locker accessory 100 subject to the same failures as prior art locker accessories.

To avoid this result, the insert molding process used by the present invention uses great care to ensure that the bond between the magnet 180 and rear wall 140 is as strong as possible. This is accomplished by carefully controlling the injection time to ensure that there are no gaps or holes in the plastic forming the locker accessory 100. The actual time used can be determined only through careful testing with a particular mold and injection equipment. In the preferred embodiment, the injection time was forty seconds. In addition, carefully controlling the cooling time ensures that the plastic has completely hardened and the magnet 180 will not shift relative to the rest of the locker accessory 100 during extraction from the mold cavity 510. If the magnet 180 did not hold to the mold 500, the cooling time could be faster, resulting in a less timely and less costly molding process.

In addition, care must be taken to ensure that the rare earth magnets 180 are not damaged due to the heat of the melted resin being injected into void 530. In the preferred embodiment, the rare earth magnets can support a temperature up to 230 degrees centigrade. This temperature is lower than the temperatures often used in injection molding machines. If this temperature is exceeded, the magnet can split, and the magnetic powder inside will spill out into and contaminate the mold 500. When this occurs, it is nearly impossible to properly clean the mold 500, and it must be replaced. To ensure that the temperature in the mold does not exceed the maximum that can be withstood by magnet 180, the temperature of the mold is controlled through water cooling.

In the preferred embodiments, the rare earth magnet 180 is a neodymium disk magnet between 10 and 12 millimeters in diameter. These magnets 180 have a magnetic force between 2040 GS and 2200 GS. The resin used in the preferred embodiment is translucent crystal styrene or an opaque high impact polystyrene (HIPS), depending on the desired appearance and shatter resistance. It is also possible to use thermoplastic rubber (TPR) and polyvinylchloride (PVC) as the selected resin. In addition, an ABS resin can be used when a particularly strong plastic is required for the locker accessory.

With some resins, such as TPR, the plastic resin is softer than with polystyrene. In these environments, it is preferable to first insert mold the rare earth magnet 600 within a harder plastic carrier 610, as shown in FIG. 15. The coated magnet assembly 620 that is created by this first step is then insert molded into the locker accessory in a second step. This is commonly referred to as “two-shot molding” or “over-molding.” In some embodiments, the magnet 600 is still formed with a dimple 602 to assist in positioning the magnet assembly 620 within the mold. To ensure that the plastic carrier 610 does not cover the dimple 602, a gap 612 is left in carrier 610 during the first step of insert molding the carrier 610.

It is also possible to insert the resulting locker accessory, such as box 100, attachment magnet 300, clip 350, or frame 400, as an insert in another insert molding step. For instance, an attachment magnet 300 of the present invention could be placed into another mold as an insert object, and have a decorative layer of a different type of plastic molded over the top of the attachment magnet 300. This remolding does not alter the fundamental nature of the present invention-the insert molding of a rare earth magnet into a locker accessory.

The present invention is not to be limited to all of the above details, as modifications and variations may be made without departing from the intent or scope of the invention. One variation would be to vary the magnet composition, size, shape, placement, or number in the locker accessories. Alternatively, the composition of the resin used to manufacture the locker accessories could be changed. Consequently, the invention should not be limited by the specifics of the above description, but rather be limited only by the following claims and equivalent constructions.

What is claimed is:

1. A method for creating a locker accessory for use in a ferromagnetic locker comprising:
a) creating a mold for the locker accessory, the mold chosen from a set of molds for locker accessories including a utility box mold, a magnetic clip mold, an attachment magnet mold, and a frame mold;
b) positioning a rare earth magnet within the mold with an outer surface of the rare earth magnet abutting the mold;
c) injecting melted resin into the mold;
d) allowing the melted resin to cool and harden sufficiently to grip the rare earth magnet; and
e) ejecting the locker accessory created by the hardened resin from the mold with the outer surface of the rare earth magnet generally parallel with an engagement surface of the locker accessory formed by the hardened resin.

2. The method of claim 1, wherein the rare earth magnet is a neodymium magnet.

3. The method of claim 1, wherein the mold is formed of steel, thereby allowing magnetic attraction between the rare earth magnet and the mold.

4. The method of claim 1, further comprising the step of:
f) before positioning the rare earth magnet, forming a hard plastic carrier around the rare earth magnet.

5. The method of claim 1, further comprising the step of forming a bump on the mold, and wherein the step of positioning a rare earth magnet further comprises positioning a dimple found on the rare earth magnet so as to interface the bump.

6. The method of claim 5, wherein the rare earth magnet is approximately flush with the engagement surface of the locker accessory.

7. The method of claim 6, wherein the step of ejecting the locker accessory from the mold further comprises ejecting the locker accessory in a direction approximately parallel with a plane formed by the engagement surface.

8. The method of claim 5, wherein the mold has a cavity and a core, and the bump is formed on the cavity of the mold.

9. The method of claim 5, wherein the magnet is a disk-shaped magnet and the dimple is a hole passing through the magnet.

10. The method of claim 1, further comprising the step of forming an indentation in the mold, and wherein the step of positioning a rare earth magnet further comprises positioning the rare earth magnet in the indentation in the mold.

11. The method of claim 10, wherein the step of ejecting the locker accessory from the mold further comprises ejecting the locker accessory in a direction approximately perpendicular with the plane formed by the engagement surface.

12. The method of claim 10 wherein the mold has a cavity and a core, and the indentation is formed on the cavity of the mold

13. The method of claims 1, wherein a plurality of rare earth magnets are positioned on the mold.

14. The locker accessory formed by the process of claim 7.

15. The locker accessory formed by the process of claim 1.

16. A method for creating a utility box locker accessory comprising:
a) creating a mold for the utility box locker accessory having a mold cavity and a mold core, the mold defining a utility box having a rear wall with an engagement surface, a front wall, two side walls, and at least one interior vertical walls;
b) inserting a rare earth magnet on a portion of the mold cavity defining the engagement surface;
c) injecting a melted resin in a void formed between the mold cavity and the mold core; and
d) allowing the melted resin to harden to form the utility box locker accessory, with the rare earth magnet having an outer surface generally flush with the engagement surface.

17. The method of claim 16, further comprising:
e) attaching the utility box locker accessory to an interior surface of a locker by abutting the engagement surface of the utility box locker accessory against the interior surface of the locker, such that the rare earth magnet magnetically interacts with locker.

18. The method of claim 16, wherein the step of inserting the rare earth magnet further comprises positioning a dimple found on the rare earth magnet so as to interface a bump found on the mold cavity.

19. The method of claim 16, further comprising the step of ejecting the locker accessory from the mold in a direction approximately parallel with a plane formed by the portion of the mold cavity defining the engagement surface

20. The utility box locker accessory created by the method of claim 16.

21. A locker accessory for use in a ferromagnetic locker, comprising:
a) a plastic molded part chosen from a set of locker accessories including a utility box, a clip, an attachment magnet, and a plastic frame, the part having a generally planar engagement surface for engagement with a surface of the locker; and
b) a rare earth magnet insert molded within the molded part such that a generally flat surface of the rare earth magnet is generally coplanar with the engagement surface of the molded part.

22. The locker accessory of claim 21, wherein the rare earth magnet has a dimple on the generally flat surface.
